(19) United States
(12) Patent Application Publication
(10) Pub. No.: US 2020/0100200 A1
(43) Pub. Date: Mar. 26, 2020

(54) METHOD, DEVICE, AND SYSTEM

(71) Applicant: HUAWEI TECHNOLOGIES CO., LTD., Shenzhen (CN)

(72) Inventors: Gaoquan LIN, Dongguan (CN); Yu LAN, Shenzhen (CN)

(21) Appl. No.: 16/695,818

(22) Filed: Nov. 26, 2019

Related U.S. Application Data
(63) Continuation of application No. PCT/CN2018/077935, filed on Mar. 2, 2018.

(30) Foreign Application Priority Data
May 26, 2017 (CN) 201710385247.3
Oct. 19, 2017 (CN) 201710977122.X

(51) Int. Cl. H04W 56/00; H04W 80/08; H04W 72/04

(52) U.S. Cl. CPC H04W 56/004; H04W 72/0446; H04W 80/08

(57) ABSTRACT

A method includes receiving, by a first device, a data packet that includes a first time information indicating a time at which the data packet arrives at a first wireless protocol layer of a second device. The first wireless protocol layer is located in a user plane protocol stack of the second device. A header of the data packet is a header of the first wireless protocol layer. The method further includes determining, by the first device, a second time information and a transmission delay of the data packet between the second device and the first device based on the first and second time information. The second time information indicates a time at which the data packet leaves a second wireless protocol layer located in a user plane protocol stack of the first device. The header of the data packet is parsed at the second wireless protocol layer.

### CROSS-REFERENCE TO RELATED APPLICATIONS

This application is a continuation of International Application No. PCT/CN2018/077935, filed on Mar. 2, 2018, which claims priority to Chinese Patent Application No. 201710385247.3, filed on May 26, 2017 and Chinese Patent Application No. 201710977122.X, filed on Oct. 19, 2017, the disclosures of which are hereby incorporated by reference in their entireties.

### TECHNICAL FIELD

This application relates to the field of communications technologies, and in particular, to a method, a device, and a system.

### BACKGROUND

In a wireless communications system, because a channel environment may change with change of time and space, when the channel environment changes, a transmission delay of a data packet between devices is affected. Generally, a base station evaluates reliability of data packet transmission by a terminal device by measuring a transmission delay of a data packet between the base station and the terminal device.

A new radio (NR) system has a higher requirement on a transmission delay and transmission reliability of a data packet between a base station and a terminal device. A manner of measuring the transmission delay in other approaches is no longer applicable to the NR system.

### SUMMARY

At least one embodiment of present disclosure provides a data packet sending method, a data packet receiving method, a device, and a system, to help improve accuracy of measurement of a transmission delay of a data packet in an NR system.

According at least one embodiment, a data packet sending method is provided, including:

A first device receives a data packet sent by a second device, where the data packet includes first time information that the data packet arrives at a packet data convergence protocol (PDCP) layer of the second device, determines second time information that the data packet leaves a PDCP layer of the first device, and then determines a transmission delay of the data packet between the second device and the first device based on the first time information and the second time information.

In at least one embodiment,the first time information and the second time information are introduced to determine the transmission delay of the data packet between the second device and the first device. However, in at least this embodiment the transmission delay of the data packet, is determined, between the second device and the first device complies with the transmission delay of the data packet defined in the NR system. Therefore, when the technical solution in this embodiment of this application is applied to the NR system, accuracy of measurement of the transmission delay of the data packet is improved.

In at least one embodiment, for data, the first device is a receive end, and the second device is a transmit end. That the data packet arrives at the PDCP layer of the second device means that the data packet that has been processed at an upper layer of the PDCP layer of the second device and that is sent to the first device is received at the PDCP layer of the second device. That the data packet leaves the PDCP layer of the first device means that after the data packet is processed at the PDCP layer of the first device, the data packet is sent to an upper layer of the PDCP layer of the first device. FIG. 1b is used as an example. If the first device is an eNB, the upper layer of the PDCP layer is a network protocol (e.g., internet protocol (IP)) layer/a user datagram protocol (UDP) layer/other (another) layer.

Based on at least one embodiment, the first time information includes first absolute time information or first relative time information. The second time information includes second absolute time information or second relative time information.

When the first time information is the first relative time information and the second time information is the second relative time information, this helps reduce a quantity of bytes used to indicate the first time information and the second time information, and therefore helps improve data packet transmission efficiency.

For example, the first time information and the second time information may be implemented in a form of a timestamp.

Based on at least one embodiment, the first relative time information may be first frame information, and/or the second relative time information may be second frame information.

The first frame information may be frame information used to carry the data packet when the data packet is received at the PDCP layer of the second device, for example, information such as a radio frame number, a subframe number, and an offset, or other identification information that identifies the radio frame number, the subframe number, and the offset. This is not limited herein.

Based on at least one embodiment,the first relative time information includes a first offset, and a first radio frame number and a first subframe number that are used when the data packet is received at the PDCP layer of the second device, and the first offset is used to indicate an offset of the data packet in a subframe identified by the first subframe number.

In a communications system, the data packet may be transmitted by using a radio frame, and therefore, an offset, a radio frame number, and a subframe number may be used to indicate a time at which the data packet is received at the PDCP layer of the second device.

Based on at least one embodiment,the first relative time information is used to indicate a interval that a first moment deviates from a first target moment, the first moment is a time at which the data packet is received at the PDCP layer of the second device, the first target moment is a start moment of a period in which the first moment is located, and duration of the period in which the first moment is located is preset duration.

Determining the first relative time information in a predefined manner helps reduce the quantity of bytes used to indicate the first time information, thereby improving the data packet transmission efficiency.

Based on at least one embodiment,the second relative time information includes a second offset, and a second radio frame number and a second subframe number that are used when the data packet is sent at the PDCP layer of the first device, and the second offset is used to indicate an offset of the data packet in a subframe identified by the second subframe number.

Based on at least one embodiment,the transmission delay T of the data packet between the second device and the first device meets the following expression:

$$T = \{ \begin{matrix}\begin{matrix}( {SFN}_{2} - {SFN}_{1} ) \times {T}_{f} + ( {SSFN}_{2} - \\ {SSFN}_{1} ) \times {T}_{sf} + ( {SOFF}_{2} - {SOFF}_{1} )\end{matrix} & {SFN}_{2} \geq {SFN}_{1} ; \\ \begin{matrix}{T}_{0} + ( {SFN}_{2} - {SFN}_{1} ) \times {T}_{f} + ( {SSFN}_{2} - \\ {SSFN}_{1} ) \times {T}_{sf} + ( {SOFF}_{2} - {SOFF}_{1} )\end{matrix} & {SFN}_{2} < {SFN}_{1} .\end{matrix} ,$$

where SFN₁ is the first radio frame number, SSFN₁ is the first subframe number, SOFF₁ is the first offset, SFN₂ is the second radio frame number, SSFN₂ is the second subframe number, SOFF₂ is the second offset, T_{f} is duration of a radio frame, T_{sf} is duration of a subframe, and T₀ is duration used for one cycle of a radio frame number.

By using the foregoing technical solution, the transmission delay of the data packet between the second device and the first device can be accurately determined.

Base on at least one embodiment,the second relative time information is used to indicate a interval that a second moment deviates from a second target moment, the second moment is a time at which the data packet is sent at the PDCP layer of the first device, the second target moment is a start moment of a period in which the second moment is located, and duration of the period in which the second moment is located is the preset duration.

Based on at least one embodiment,the transmission delay T of the data packet between the second device and the first device meets the following expression:

$$T = \{ \begin{matrix}{T}_{2} - {T}_{1} & {T}_{2} > {T}_{1} ; \\ {T}_{z} + ( {T}_{2} - {T}_{1} ) & {T}_{2} \leq {T}_{1} .\end{matrix} ,$$

where T₁ is the first relative time information, T₂ the second relative time information, and T_{z} is the preset duration.

By using the foregoing technical solution, complexity of determining the transmission delay of the data packet can be reduced based on accurately determining the transmission delay of the data packet between the second device and the first device.

Based on at least one embodiment,the data packet further includes a first identifier. The first identifier is used to identify a format used for the first time information.

During specific implementation, the first device may use the following manner to determine the second time information that the data packet leaves the PDCP layer of the first device:

the first device determines, based on the format that is used for the first time information and that is identified by the first identifier, the second time information that the data packet leaves the PDCP layer of the first device.

By using the foregoing technical solution, a same format is used for the first time information and the second time information, thereby simplifying a manner of determining the transmission delay of the data packet between the first device and the second device.

Based on at least one embodiment, the first time information and the first identifier are carried in a PDCP header of the data packet.

Based on at least one embodiment, when the first device is a terminal device and the second device is a network device, the first device further sends the transmission delay to the second device.

When the first device is a terminal device and the second device is a network device, the first device further sends the transmission delay to the second device. This helps the network device evaluate reliability of a data packet in communication of the terminal device.

For example, the first device may send the transmission delay to the second device each time after determining the transmission delay of the data packet; or the first device may send, to the second device every preset duration, transmission delays of all data packets determined by the first device in the preset duration. In addition, the first device may alternatively send transmission delays of a preset quantity of data packets to the second device each time after determining the transmission delays of the preset quantity of data packets, or the first device is triggered by an event to send the transmission delay of the data packet to the second device, for example, the determined transmission delay of the data packet is greater than a specific threshold. It should be further noted that the first device may further collect statistics about an average value of determined transmission delays of all the data packets every preset duration, and send the average value of the transmission delays to the second device, or the first device collects statistics about the transmission delays of the preset quantity of data packets each time after determining the transmission delays of the preset quantity of data packets, for example, determines an average value of the transmission delays of the preset quantity of data packets, and sends a statistical result of the statistical transmission delays of the data packets to the second device.

According to at least one embodiment, the present disclosure includes a data packet sending method, including:

A second device determines first time information that a data packet arrives at a PDCP layer of the second device, and sends the data packet to a first device, where the data packet includes the first time information, so that the first device determines, based on the first time information, a transmission delay of the data packet between the second device and the first device.

In at least one embodiment, when the second device sends the data packet, the first time information is introduced, so that the first device can determine the transmission delay of the data packet based on the first time information. However, in at least this embodiment, the manner of determining the transmission delay of the data packet complies with a definition of the transmission delay of the data packet in the NR system. Therefore, when the technical solution in this embodiment of this application is applied to the NR system, accuracy of measurement of the transmission delay of the data packet is improved.

Based on at least one embodiment, the first time information includes first absolute time information or first relative time information.

When the first time information is the first relative time information and second time information is second relative time information, this helps reduce a quantity of bytes used to indicate the first time information and the second time information, and therefore helps improve data packet transmission efficiency.

For example, the first time information may be implemented in a form of a timestamp.

Based on at least one embodiment, the first relative time information may be first frame information.

The first frame information may be frame information used to carry the data packet when the data packet is received at the PDCP layer of the second device, for example, information such as a radio frame number, a subframe number, and an offset, or other identification information that identifies the radio frame number, the subframe number, and the offset. This is not limited herein.

Based on at least one embodiment, the first relative time information includes a first offset, and a first radio frame number and a first subframe number that are used when the data packet is received at the PDCP layer of the second device, and the first offset is used to indicate an offset of the data packet in a subframe identified by the first subframe number.

In a communications system, the data packet may be transmitted by using a radio frame, and therefore, an offset, a radio frame number, and a subframe number may be used to indicate a time at which the data packet is received at the PDCP layer of the second device.

Based on at least one embodiment,the first relative time information is used to indicate a interval that a first moment deviates from a first target moment, the first moment is a time at which the data packet is received at the PDCP layer of the second device, the first target moment is a start moment of a period in which the first moment is located, and duration of the period in which the first moment is located is preset duration.

Determining the first relative time information in a predefined manner helps reduce the quantity of bytes used to indicate the first time information, thereby improving the data packet transmission efficiency.

Based on at least one embodiment, the data packet further includes a first identifier. The first identifier is used to identify a format used for the first time information.

By using the foregoing technical solution, the second device may notify the first device of the format used for the first time information, so that the first device can use a same format as that used for the first time information when determining the second time information. This helps simplify a manner of determining the transmission delay of the data packet between the first device and the second device.

Based on at least one embodiment, the first time information and the first identifier are carried in a PDCP header of the data packet.

Based on at least one embodiment, when the first device is a terminal device and the second device is a network device, the second device further receives the transmission delay of the data packet that is between the first device and the second device and that is sent by the first device, and presents the transmission delay in a form of a log or traffic statistics.

When the first device is a terminal device and the second device is a network device, the second device further receives the transmission delay sent by the first device. This helps the network device evaluate reliability of a data packet in communication of the terminal device.

For example, when the first device sends the transmission delay of the data packet to the second device each time after determining the transmission delay of the data packet, the second device directly receives the transmission delay of the data packet. When the first device sends, to the second device every preset duration, transmission delays of all data packets determined by the first device in the preset duration, the second device may periodically receive the transmission delays of the data packets sent by the first device. In addition, after determining the transmission delays of a preset quantity of data packets, the first device sends the transmission delays of the preset quantity of data packets to the second device, and the second device may receive the preset quantity of transmission delays; or the first device may be triggered by an event to send the transmission delay of the data packet to the second device, for example, the determined transmission delay of the data packet is greater than a specific threshold. It should be further noted that the first device may further collect statistics about an average value of determined transmission delays of all the data packets every preset duration, and send the average value of the transmission delays to the second device, or the first device collects statistics about transmission delays of the preset quantity of data packets each time after determining the transmission delays of the preset quantity of data packets, for example, determines an average value of the transmission delays of the preset quantity of data packets, and sends a statistical result of the statistical transmission delays of the data packets to the second device.

According to at least one embodiment,a data packet receiving device includes a transceiver and a processor, where the transceiver is configured to receive a data packet sent by a second device, and the data packet includes first time information that the data packet arrives at a packet data convergence protocol PDCP layer of the second device; and the processor is configured to: determine second time information that the data packet leaves the PDCP layer of the device, and determine a transmission delay of the data packet between the second device and the device based on the first time information and the second time information.

Based on at least one embodiment,the first time information includes first absolute time information or first relative time information. The second time information includes second absolute time information or second relative time information.

Based on at least one embodiment,the first relative time information includes a first offset, and a first radio frame number and a first subframe number that are used when the data packet is received at the PDCP layer of the second device, and the first offset is used to indicate an offset of the data packet in a subframe identified by the first subframe number.

Based on at least one embodiment,the first relative time information is used to indicate a interval that a first moment deviates from a first target moment, the first moment is a time at which the data packet is received at the PDCP layer of the second device, the first target moment is a start moment of a period in which the first moment is located, and duration of the period in which the first moment is located is preset duration.

Based on at least one embodiment,the second relative time information includes a second offset, and a second radio frame number and a second subframe number that are used when the data packet is sent at the PDCP layer of the device, and the second offset is used to indicate an offset of the data packet in a subframe identified by the second subframe number.

Based on at least one embodiment, the transmission delay T of the data packet between the second device and the device meets the following expression:

$$T = \{ \begin{matrix}\begin{matrix}( {SFN}_{2} - {SFN}_{1} ) \times {T}_{f} + ( {SSFN}_{2} - \\ {SSFN}_{1} ) \times {T}_{sf} + ( {SOFF}_{2} - {SOFF}_{1} )\end{matrix} & {SFN}_{2} \geq {SFN}_{1} ; \\ \begin{matrix}{T}_{0} + ( {SFN}_{2} - {SFN}_{1} ) \times {T}_{f} + ( {SSFN}_{2} - \\ {SSFN}_{1} ) \times {T}_{sf} + ( {SOFF}_{2} - {SOFF}_{1} )\end{matrix} & {SFN}_{2} < {SFN}_{1} .\end{matrix} ,$$

where SFN₁ is the first radio frame number, SSFN₁ is the first subframe number, SOFF₁ is the first offset, SFN₂ is the second radio frame number, SSFN₂ is the second subframe number, SOFF₂ is the second offset, T_{f} is duration of a radio frame, T_{sf} is duration of a subframe, and T₀ is duration used for one cycle of a radio frame number.

Base on at least one embodiment,the second relative time information is used to indicate a interval that a second moment deviates from a second target moment, the second moment is a time at which the data packet is sent at the PDCP layer of the device, the second target moment is a start moment of a period in which the second moment is located, and duration of the period in which the second moment is located is the preset duration.

Based on at least one embodiment,the transmission delay T of the data packet between the second device and the device meets the following expression:

$$T = \{ \begin{matrix}{T}_{2} - {T}_{1} & {T}_{2} > {T}_{1} ; \\ {T}_{z} + ( {T}_{2} - {T}_{1} ) & {T}_{2} \leq {T}_{1} .\end{matrix} ,$$

where T₁ is the first relative time information, T₂ the second relative time information, and T_{z} is the preset duration.

Based on at least one embodiment,the data packet further includes a first identifier. The first identifier is used to identify a format used for the first time information.

In some embodiments, the processor is configured to determine the second time information that the data packet leaves the PDCP layer of the device specifically includes:

the processor is configured to determine, based on the format that is used for the first time information and that is identified by the first identifier, the second time information that the data packet leaves the PDCP layer of the device.

Based on at least one embodiment,the first time information and the first identifier are carried in a PDCP header of the data packet.

Based on at least one embodiment,when the device is a terminal device and the second device is a network device, the transceiver is further configured to send the transmission delay to the second device.

According to at least one embodiment,a data packet receiving device includes a transceiver and a processor, where the transceiver is configured to receive a data packet sent by a second device, and the data packet includes first time information that the data packet arrives at a packet data convergence protocol PDCP layer of the second device; and the processor is configured to: determine second time information that the data packet leaves the PDCP layer of the device, and determine a transmission delay of the data packet between the second device and the device based on the first time information and the second time information.

Based on at least one embodiment,the first time information includes first absolute time information or first relative time information. The second time information includes second absolute time information or second relative time information.

Based on at least one embodiment,the first relative time information includes a first offset, and a first radio frame number and a first subframe number that are used when the data packet is received at the PDCP layer of the second device, and the first offset is used to indicate an offset of the data packet in a subframe identified by the first subframe number.

Based on at least one embodiment, the first relative time information is used to indicate a interval that a first moment deviates from a first target moment, the first moment is a time at which the data packet is received at the PDCP layer of the second device, the first target moment is a start moment of a period in which the first moment is located, and duration of the period in which the first moment is located is preset duration.

Based on at least one embodiment, the second relative time information includes a second offset, and a second radio frame number and a second subframe number that are used when the data packet is sent at the PDCP layer of the device, and the second offset is used to indicate an offset of the data packet in a subframe identified by the second subframe number.

Based on at least one embodiment,the transmission delay T of the data packet between the second device and the device meets the following expression:

$$T = \{ \begin{matrix}( {SFN}_{2} - {SFN}_{1} ) \times {T}_{f} + ( {SSFN}_{2} - {SSFN}_{1} ) \times {T}_{sf} + ( {SOFF}_{2} - {SOFF}_{1} ) & {SFN}_{2} \geq {SFN}_{1} ; \\ {T}_{0} + ( {SFN}_{2} - {SFN}_{1} ) \times {T}_{f} + ( {SSFN}_{2} - {SSFN}_{1} ) \times {T}_{sf} + ( {SOFF}_{2} - {SOFF}_{1} ) & {SFN}_{2} < {SFN}_{1} .\end{matrix} ,$$

where SFN₁ is the first radio frame number, SSFN₁ is the first subframe number, SOFF₁ is the first offset, SFN₂ is the second radio frame number, SSFN₂ is the second subframe number, SOFF₂ is the second offset, T_{f} is duration of a radio frame, T_{sf} is duration of a subframe, and T₀ is duration used for one cycle of a radio frame number.

Base on at least one embodiment,the second relative time information is used to indicate a interval that a second moment deviates from a second target moment, the second moment is a time at which the data packet is sent at the PDCP layer of the device, the second target moment is a start moment of a period in which the second moment is located, and duration of the period in which the second moment is located is the preset duration.

Based on at least one embodiment, the transmission delay T of the data packet between the second device and the device meets the following expression:

$$T = \{ \begin{matrix}{T}_{2} - {T}_{1} & {T}_{2} > {T}_{1} ; \\ {T}_{z} + ( {T}_{2} - {T}_{1} ) & {T}_{2} \leq {T}_{1} .\end{matrix} ,$$

where T₁ is the first relative time information, T₂ the second relative time information, and T_{z} is the preset duration.

Based on at least one embodiment, the data packet further includes a first identifier. The first identifier is used to identify a format used for the first time information.

In some embodiments, the processor is configured to determine the second time information that the data packet leaves the PDCP layer of the device specifically includes:

the processor is configured to determine, based on the format that is used for the first time information and that is identified by the first identifier, the second time information that the data packet leaves the PDCP layer of the device.

Based on at least one embodiment, the first time information and the first identifier are carried in a PDCP header of the data packet.

Based on at least one embodiment,when the device is a terminal device and the second device is a network device, the transceiver is further configured to send the transmission delay to the second device.

According to at least one embodiment, the present disclosure includes a computer readable storage medium. The computer readable storage medium stores an instruction. When the instruction is run on a computer, the computer is enabled to perform the method in the foregoing aspects.

According to at least one embodiment, the present disclosure includes a computer program product including an instruction. When the computer program product is run on a computer, the computer is enabled to perform the method in at least the foregoing embodiments.

According to at least one embodiment, the present disclosure includes a chip, where the chip is connected to a memory, and is configured to read a program instruction in the memory, to implement the technical solution in any one of the previous embodiments or designs provided in at least one of the previous embodiments.

According to at least one embodiment, the present disclosure includes a data packet sending device. The device includes a processor and a transceiver. The processor is configured to determine first time information that a data packet arrives at a packet data convergence protocol PDCP layer of the device. The transceiver is configured to send the data packet to a first device, where the data packet includes the first time information, so that the first device determines a transmission delay of the data packet between the device and the first device based on the first time information.

Based on at least one embodiment,the first time information includes first absolute time information or first relative time information.

Based on at least one embodiment, the first relative time information includes a first offset, and a first radio frame number and a first subframe number that are used when the data packet is received at the PDCP layer of the device, and the first offset is used to indicate an offset of the data packet in a subframe identified by the first subframe number.

Based on at least one embodiment, the first relative time information is used to indicate a interval that a first moment deviates from a first target moment, the first moment is a time at which the data packet is received at the PDCP layer of the device, the first target moment is a start moment of a period in which the first moment is located, and duration of the period in which the first moment is located is preset duration.

Based on at least one embodiment, the data packet further includes a first identifier. The first identifier is used to identify a format used for the first time information.

Based on at least one embodiment, the first time information and the first identifier are carried in a PDCP header of the data packet.

Based on at least one embodiment, when the first device is a terminal device and the device is a network device, the transceiver is further configured to: receive the transmission delay of the data packet that is between the first device and the second device and that is sent by the first device, and present the transmission delay in a form of a log or traffic statistics.

According to at least one embodiment, the present disclosure includes a data packet sending device. The device includes a processor and a transceiver. The processor is configured to determine first time information that a data packet arrives at a packet data convergence protocol PDCP layer of the device. The transceiver is configured to send the data packet to a first device, where the data packet includes the first time information, so that the first device determines a transmission delay of the data packet between the device and the first device based on the first time information.

Based on at least one embodiment, the first time information includes first absolute time information or first relative time information.

Based on at least one embodiment, the first relative time information includes a first offset, and a first radio frame number and a first subframe number that are used when the data packet is received at the PDCP layer of the device, and the first offset is used to indicate an offset of the data packet in a subframe identified by the first subframe number.

Based on at least one embodiment, the first relative time information is used to indicate a interval that a first moment deviates from a first target moment, the first moment is a time at which the data packet is received at the PDCP layer of the device, the first target moment is a start moment of a period in which the first moment is located, and duration of the period in which the first moment is located is preset duration.

Based on at least one embodiment, the data packet further includes a first identifier. The first identifier is used to identify a format used for the first time information.

Based on at least one embodiment, the first time information and the first identifier are carried in a PDCP header of the data packet.

Based on at least one embodiment, when the first device is a terminal device and the device is a network device, the transceiver is further configured to: receive the transmission delay of the data packet that is between the first device and the second device and that is sent by the first device, and present the transmission delay in a form of a log or traffic statistics.

According to at least one embodiment, the present disclosure includes a computer readable storage medium. The computer readable storage medium stores an instruction. When the instruction is run on a computer, the computer is enabled to perform the method in the foregoing aspects.

According to at least one embodiment, the present disclosure includes a computer program product including an instruction. When the computer program product is run on a computer, the computer is enabled to perform the method in the foregoing aspects.

According to at least one embodiment, the present disclosure includes a chip, where the chip is connected to a memory, and is configured to read a program instruction in the memory, to implement the technical solution in any one of the second aspect and the designs provided in the second aspect.

According to at least one embodiment, the present disclosure includes a communications system, including the device in any one of the third aspect and the designs provided in the third aspect, and the device in any one of the fifth aspect and the designs provided in the fifth aspect.

According to at least one embodiment, the present disclosure includes a data packet receiving method, including:

A first device receives a data packet sent by a second device, where the data packet includes first time information, determines second time information, and then determines a transmission delay of the data packet between the second device and the first device based on the first time information and the second time information. The first time information is used to indicate a time at which the data packet arrives at a first wireless protocol layer, the first wireless protocol layer is located in a user plane protocol stack of the second device, and a header of the data packet is a header of the first wireless protocol layer. The second time information is used to indicate a time at which the data packet leaves a second wireless protocol layer, the second wireless protocol layer is located in a user plane protocol stack of the first device, and the header of the data packet is parsed at the second wireless protocol layer.

In at least one embodiment, the first time information and the second time information are introduced to determine the transmission delay of the data packet between the second device and the first device. However, in at least this embodiment, the transmission delay of the data packet, is determined, between the second device and the first device complies with the transmission delay of the data packet defined in the NR system. Therefore, when the technical solution of at least this embodiment is applied to the NR system, accuracy of measurement of the transmission delay of the data packet is improved.

In at least one embodiment, the first wireless protocol layer is a PDCP layer of the second device, and the second wireless protocol layer is a PDCP layer of the first device; or the first wireless protocol layer is a service data adaptation protocol (SDAP) layer of the second device, and the second wireless protocol layer is an SDAP layer of the first device.

In at least one embodiment, the first time information includes first absolute time information or first relative time information. The second time information includes second absolute time information or second relative time information.

When the first time information is the first relative time information and the second time information is the second relative time information, this helps reduce a quantity of bytes used to indicate the first time information and the second time information, and therefore helps improve data packet transmission efficiency.

For example, the first time information and the second time information may be implemented in a form of a timestamp.

In at least one embodiment, the first relative time information includes a first offset, and a first radio frame number and a first subframe number that are used when the data packet is received at the first wireless protocol layer, and the first offset is used to indicate an offset of the data packet in a subframe identified by the first subframe number.

In at least one embodiment,the first relative time information is used to indicate a interval that a first moment deviates from a first target moment, the first moment is a time at which the data packet is received at the first wireless protocol layer, the first target moment is a start moment of a period in which the first moment is located, and duration of the period in which the first moment is located is preset duration. Determining the first relative time information in the foregoing manner helps reduce the quantity of bytes used to indicate the first time information, thereby improving the data packet transmission efficiency.

In at least one embodiment, the second relative time information includes a second offset, and a second radio frame number and a second subframe number that are used when the data packet is sent at the second wireless protocol layer, and the second offset is used to indicate an offset of the data packet in a subframe identified by the second subframe number.

In at least one embodiment, the transmission delay T of the data packet between the second device and the first device meets the following expression:

$$T = \{ \begin{matrix}( {SFN}_{2} - {SFN}_{1} ) \times {T}_{f} + ( {SSFN}_{2} - {SSFN}_{1} ) \times {T}_{sf} + ( {SOFF}_{2} - {SOFF}_{1} ) & {SFN}_{2} \geq {SFN}_{1} ; \\ {T}_{0} + ( {SFN}_{2} - {SFN}_{1} ) \times {T}_{f} + ( {SSFN}_{2} - {SSFN}_{1} ) \times {T}_{sf} + ( {SOFF}_{2} - {SOFF}_{1} ) & {SFN}_{2} < {SFN}_{1} .\end{matrix} ,$$

where SFN₁ is the first radio frame number used when the data packet is received at the first wireless protocol layer, SSFN₁ is the first subframe number used when the data packet is received at the first wireless protocol layer, SOFF₁ is the first offset, the first offset is used to indicate an offset of the data packet in a subframe identified by the first subframe number, SFN₂ is the second radio frame number used when the data packet is sent at the second wireless protocol layer, SSFN₂ is the second subframe number used when the data packet is sent at the second wireless protocol layer, SOFF₂ is the second offset, the second offset is used to indicate an offset of the data packet in a subframe identified by the second subframe number, T_{f} is duration of a radio frame, T_{sf} is duration of a subframe, and T₀ is duration used for one cycle of a radio frame number.

The foregoing technical solution helps accurately determine the transmission delay of the data packet between the second device and the first device.

In at least one embodiment,the second relative time information is used to indicate a interval that a second moment deviates from a second target moment, the second moment is a time at which the data packet is sent at the second wireless protocol layer, the second target moment is a start moment of a period in which the second moment is located, and duration of the period in which the second moment is located is the preset duration.

In at least one embodiment, the transmission delay T of the data packet between the second device and the first device meets the following expression:

$$T = \{ \begin{matrix}{T}_{2} - {T}_{1} & {T}_{2} > {T}_{1} ; \\ {T}_{z} + ( {T}_{2} - {T}_{1} ) & {T}_{2} \leq {T}_{1} .\end{matrix} ,$$

where T₁ is the first relative time information, the first relative time information is used to indicate a interval that a first moment deviates from a first target moment, the first moment is a time at which the data packet is received at the first wireless protocol layer, the first target moment is a start moment of a period in which the first moment is located, and duration of the period in which the first moment is located is T_{z}, T₂ is the second relative time information, the second relative time information is used to indicate a interval that a second moment deviates from a second target moment, the second moment is a time at which the data packet is sent at the second wireless protocol layer, the second target moment is a start moment of a period in which the second moment is located, and duration of the period in which the second moment is located is T_{z}, and T_{z} is the preset duration.

By using the foregoing technical solution, complexity of determining the transmission delay of the data packet can be reduced based on accurately determining the transmission delay of the data packet between the second device and the first device.

In at least one embodiment, the data packet further includes a first identifier. The first identifier is used to identify a format used for the first time information. During a specific implementation, the following manner can be used.

The first device determines the second time information based on the format that is used for the first time information and that is identified by the first identifier. By using the foregoing technical solution, a same format is used for the first time information and the second time information, thereby simplifying a manner of determining the transmission delay of the data packet between the first device and the second device.

According to at least one embodiment, the present disclosure includes a data packet sending method, including:

A second device determines first time information, and sends a data packet to a first device, where the data packet includes the first time information, the first time information is used to indicate a time at which the data packet arrives at a first wireless protocol layer, the first wireless protocol layer is located in a user plane protocol stack of the second device, and a header of the data packet is a header of the first wireless protocol layer.

In at least one embodiment, when the second device sends the data packet, the first time information is introduced, so that the first device can determine the transmission delay of the data packet based on the first time information. However, in at least this embodiment determining the transmission delay of the data packet complies with a definition of the transmission delay of the data packet in the NR system. Therefore, when the technical solution of at least this embodiment is applied to the NR system, accuracy of measurement of the transmission delay of the data packet is improved.

In at least one embodiment, the first wireless protocol layer is a packet data convergence protocol PDCP layer of the second device; or the first wireless protocol layer is an SDAP layer of the second device.

In at least one embodiment, the first time information includes first absolute time information or first relative time information. When the first time information is the first relative time information and second time information is second relative time information, this helps reduce a quantity of bytes used to indicate the first time information and the second time information, and therefore helps improve data packet transmission efficiency.

For example, the first time information may be implemented in a form of a timestamp.

In at least one embodiment, the first relative time information includes a first offset, and a first radio frame number and a first subframe number that are used when the data packet is received at the first wireless protocol layer, and the first offset is used to indicate an offset of the data packet in a subframe identified by the first subframe number.

In at least one embodiment, the first relative time information is used to indicate a interval that a first moment deviates from a first target moment, the first moment is a time at which the data packet is received at the first wireless protocol layer, the first target moment is a start moment of a period in which the first moment is located, and duration of the period in which the first moment is located is preset duration. Determining the first relative time information in the foregoing manner helps reduce the quantity of bytes used to indicate the first time information, thereby improving the data packet transmission efficiency.

In at least one embodiment, the data packet further includes a first identifier. The first identifier is used to identify a format used for the first time information. By using the foregoing technical solution, the second device may notify the first device of the format used for the first time information, so that the first device can use a same format as that used for the first time information when determining the second time information. This helps simplify a manner of determining the transmission delay of the data packet between the first device and the second device.

According to at least one embodiment, the present disclosure includes a first device, including a processor and a transceiver. The transceiver id configured to receive a data packet sent by a second device, where the data packet includes first time information, the first time information is used to indicate a time at which the data packet arrives at a first wireless protocol layer, the first wireless protocol layer is located in a user plane protocol stack of the second device, and a header of the data packet is a header of the first wireless protocol layer. The processor is configured to: determine second time information, and determine a transmission delay of the data packet between the second device and the first device based on the first time information and the second time information, where the second time information is used to indicate a time at which the data packet leaves a second wireless protocol layer, the second wireless protocol layer is located in a user plane protocol stack of the first device, and the header of the data packet is parsed at the second wireless protocol layer.

In at least one embodiment, the first wireless protocol layer is a packet data convergence protocol PDCP layer of the second device, and the second wireless protocol layer is a PDCP layer of the first device; or the first wireless protocol layer is a service data adaptation protocol SDAP layer of the second device, and the second wireless protocol layer is an SDAP layer of the first device.

In at least one embodiment, the first time information includes first absolute time information or first relative time information. The second time information includes second absolute time information or second relative time information.

In at least one embodiment, the first relative time information includes a first offset, and a first radio frame number and a first subframe number that are used when the data packet is received at the first wireless protocol layer, and the first offset is used to indicate an offset of the data packet in a subframe identified by the first subframe number.

In at least one embodiment, the first relative time information is used to indicate a interval that a first moment deviates from a first target moment, the first moment is a time at which the data packet is received at the first wireless protocol layer, the first target moment is a start moment of a period in which the first moment is located, and duration of the period in which the first moment is located is preset duration.

In at least one embodiment, the second relative time information includes a second offset, and a second radio frame number and a second subframe number that are used when the data packet is sent at the second wireless protocol layer, and the second offset is used to indicate an offset of the data packet in a subframe identified by the second subframe number.

In at least one embodiment, the transmission delay T of the data packet between the second device and the first device meets the following expression:

$$T = \{ \begin{matrix}( {SFN}_{2} - {SFN}_{1} ) \times {T}_{f} + ( {SSFN}_{2} - {SSFN}_{1} ) \times {T}_{sf} + ( {SOFF}_{2} - {SOFF}_{1} ) & {SFN}_{2} \geq {SFN}_{1} ; \\ {T}_{0} + ( {SFN}_{2} - {SFN}_{1} ) \times {T}_{f} + ( {SSFN}_{2} - {SSFN}_{1} ) \times {T}_{sf} + ( {SOFF}_{2} - {SOFF}_{1} ) & {SFN}_{2} < {SFN}_{1} .\end{matrix} ,$$

where SFN₁ is the first radio frame number used when the data packet is received at the first wireless protocol layer, SSFN₁ is the first subframe number used when the data packet is received at the first wireless protocol layer, SOFF₁ is the first offset, the first offset is used to indicate an offset of the data packet in a subframe identified by the first subframe number, SFN₂ is the second radio frame number used when the data packet is sent at the second wireless protocol layer, SSFN₂ is the second subframe number used when the data packet is sent at the second wireless protocol layer, SOFF₂ is the second offset, the second offset is used to indicate an offset of the data packet in a subframe identified by the second subframe number, T_{f} is duration of a radio frame, T_{sf} is duration of a subframe, and T₀ is duration used for one cycle of a radio frame number.

In at least one embodiment, the second relative time information is used to indicate a interval that a second moment deviates from a second target moment, the second moment is a time at which the data packet is sent at the second wireless protocol layer, the second target moment is a start moment of a period in which the second moment is located, and duration of the period in which the second moment is located is the preset duration.

In at least one embodiment, the transmission delay T of the data packet between the second device and the first device meets the following expression:

$$T = \{ \begin{matrix}{T}_{2} - {T}_{1} & {T}_{2} > {T}_{1} ; \\ {T}_{z} + ( {T}_{2} - {T}_{1} ) & {T}_{2} \leq {T}_{1} .\end{matrix} ,$$

where T₁ is the first relative time information, the first relative time information is used to indicate a interval that a first moment deviates from a first target moment, the first moment is a time at which the data packet is received at the first wireless protocol layer, the first target moment is a start moment of a period in which the first moment is located, and duration of the period in which the first moment is located is T_{z}, T₂ is the second relative time information, the second relative time information is used to indicate a interval that a second moment deviates from a second target moment, the second moment is a time at which the data packet is sent at the second wireless protocol layer, the second target moment is a start moment of a period in which the second moment is located, and duration of the period in which the second moment is located is T_{z}, and T_{z} is the preset duration.

In at least one embodiment, the data packet further includes a first identifier. The first identifier is used to identify a format used for the first time information.

In some embodiments, the processor is configured to determine the second time information includes

the processor is configured to determine the second time information based on the format that is used for the first time information and that is identified by the first identifier.

According to at least one embodiment, the present disclosure includes a second device, including a processor and a transceiver, where the processor is configured to determine first time information, the first time information is used to indicate a time at which a data packet arrives at a first wireless protocol layer, the first wireless protocol layer is located in a user plane protocol stack of the second device, and a header of the data packet is a header of the first wireless protocol layer; and the transceiver is configured to send the data packet to a first device, where the data packet includes the first time information.

In at least one embodiment, the first wireless protocol layer is a packet data convergence protocol PDCP layer of the second device; or the first wireless protocol layer is a service data adaptation protocol SDAP layer of the second device.

In at least one embodiment, the first time information includes first absolute time information or first relative time information.

In at least one embodiment, the first relative time information includes a first offset, and a first radio frame number and a first subframe number that are used when the data packet is received at the first wireless protocol layer, and the first offset is used to indicate an offset of the data packet in a subframe identified by the first subframe number.

In at least one embodiment, the first relative time information is used to indicate a interval that a first moment deviates from a first target moment, the first moment is a time at which the data packet is received at the first wireless protocol layer, the first target moment is a start moment of a period in which the first moment is located, and duration of the period in which the first moment is located is preset duration.

According to at least one embodiment, the present disclosure includes a computer readable storage medium. The computer readable storage medium stores an instruction. When the instruction is run on a computer, the computer is enabled to perform the method in any one of the previous embodiments.

According to at least one embodiment, the present disclosure includes a computer readable storage medium. The computer readable storage medium stores an instruction. When the instruction is run on a computer, the computer is enabled to perform the method in any one of the previous embodiments.

According to at least one embodiment, the present disclosure includes a computer program product including an instruction. When the computer program product is run on a computer, the computer is enabled to perform the method in any one of the previous embodiments.

According to at least one embodiment, the present disclosure includes a computer program product including an instruction. When the computer program product is run on a computer, the computer is enabled to perform the method in any one of the previous embodiments.

According to at least one embodiment, the present disclosure includes a chip, where the chip is connected to a memory, and is configured to read a program instruction in the memory, to implement the technical solution in any one of the previous embodiments.

According to at least one embodiment, the present disclosure includes a chip, where the chip is connected to a memory, and is configured to read a program instruction in the memory, to implement the technical solution in any one of the previous embodiments.

According to at least one embodiment, the present disclosure includes a communications system, including the device in any one of the previous embodiments.

### BRIEF DESCRIPTION OF DRAWINGS

FIG. 1a and FIG. 1b each are a schematic diagram of a transmission delay according to at least an embodiment of the present application;

FIG. 2 is a schematic flowchart of a data packet sending and receiving method according to an embodiment of the present application;

FIG. 3a to FIG. 3c each are a schematic structural diagram of first time information according to an embodiment of the present application;

FIG. 4 is a schematic diagram of an offset according to an embodiment of the present application;

FIG. 5 is a schematic diagram of first relative time information according to an embodiment of the present application;

FIG. 6a and FIG. 6b each are a schematic structural diagram of a data packet according to an embodiment of the present application;

FIG. 7a is a schematic diagram of a cloud scenario according to an embodiment of the present application;

FIG. 7b is a schematic diagram of a non-cloud scenario according to an embodiment of the present application;

FIG. 8 is a schematic diagram of a transmission delay calculation process according to an embodiment of the present application;

FIG. 9a and FIG. 9b each are a schematic structural diagram of a data packet receiving device according to an embodiment of the present application;

FIG. 10a and FIG. 10b each are a schematic structural diagram of a data packet sending device according to an embodiment of the present application; and

FIG. 11 is a schematic structural diagram of a communications system according to an embodiment of the present application.

### DETAILED DESCRIPTION

To make a person skilled in the art understand the solutions in the present disclosure better, the following describes several embodiments in more detail with reference to the accompanying drawings and implementations. Apparently, the described embodiments are some rather than all of the embodiments of the present disclosure. All other embodiments obtained by a person of ordinary skill in the art based on the embodiments of the present disclosure without creative efforts shall fall within the protection scope of the present disclosure.

The following describes embodiments of the present application correspondingly with reference to the accompanying drawings in this specification.

In at least one embodiment, for an NR system, a transmission delay of a data packet between a base station and a terminal device in a communication protocol is defined as in an uplink communication direction or a downlink communication direction, a period of time in which the data packet or information is successfully transmitted from a service data unit (SDU) entry point of a wireless protocol layer 2 or a wireless protocol layer 3 to an SDU exit point of the wireless protocol layer 2 or the wireless protocol layer 3, regardless of whether the terminal device or the base station is limited by discontinuous reception (DRX).

In the embodiments of the present application, for ease of determining an air interface delay of the data packet, a first wireless protocol layer in a user plane protocol stack is used as the SDU entry point, and a second wireless protocol layer in the user plane protocol stack is used as the SDU exit point. The first wireless protocol layer and the second wireless protocol layer may be a same wireless protocol layer, or may be defined as different wireless protocol layers, and may be correspondingly set based on an actual situation.

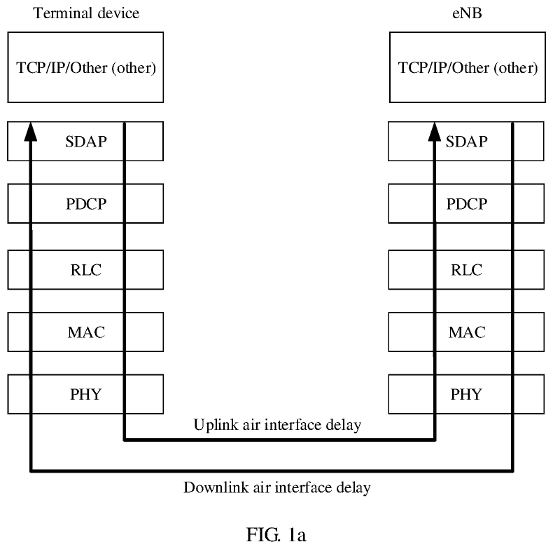

For example, generally, as shown in FIG. 1a, the user plane protocol stack includes a media access control (MAC) layer, a radio link control (RLC) layer, and a PDCP layer, and a header of the data packet is a header of the PDCP layer. In some embodiments, the first wireless protocol layer is the PDCP layer, and the second wireless protocol layer is also the PDCP layer. A service data adaptation protocol (SDAP) layer located above the PDCP layer is introduced in a user plane protocol stack in fifth generation (5G) network. As shown in FIG. 1b, when the data packet passes through the SDAP layer, and the header of the data packet becomes a header of the SDAP layer, the first wireless protocol layer is the SDAP layer, and the second wireless protocol layer is the SDAP layer in some embodiments. When the header of the data packet passes through the SDAP layer, and the header of the data packet is still the header of the PDCP layer, to be specific, the data packet is transparently transmitted at the SDAP layer. In some embodiments, the first wireless protocol layer is the PDCP layer, and the second wireless protocol layer is also the PDCP layer.

The following uses an example in which the first wireless protocol layer is the PDCP layer and the second wireless protocol layer is the PDCP layer for specific description. When the first wireless protocol layer is the SDAP layer, and the second wireless protocol layer is the SDAP layer, or the first wireless protocol layer and the second wireless protocol layer each are another layer, a manner of determining the air interface delay is similar. Details are not described herein again.

For an NR system, a transmission delay of a data packet between a base station and a terminal device in a communication protocol is defined as shown in FIG. 1a: in an uplink communication direction or a downlink communication direction, a period of time in which the data packet or information is successfully transmitted from a service data unit (SDU) entry point of a wireless protocol layer 2 or a wireless protocol layer 3 to an SDU exit point of the wireless protocol layer 2 or the wireless protocol layer 3, regardless of whether the terminal device or the base station is limited by discontinuous reception (DRX).

Specifically, in the uplink communication direction, the SDU entry point of the wireless protocol layer 2 or the wireless protocol layer 3 is the PDCP layer of the terminal device shown in FIG. 1a, and the SDU exit point of the wireless protocol layer 2 or the wireless protocol layer 3 is the PDCP layer of an evolved NodeB (eNB) shown in FIG. 1. In the downlink communication direction, the SDU entry point of the wireless protocol layer 2 or the wireless protocol layer 3 is the PDCP layer of the eNB shown in FIG. 1, and the SDU exit point of the wireless protocol layer 2 or the wireless protocol layer 3 is the PDCP layer of the terminal device shown in FIG 1a.

It should be understood that the embodiments of the present application may be applied to but is not limited to the NR system.

It should be understood that, in the embodiments of the present application, when a first device is a network device, a second device is a terminal device; when the first device is a terminal device, the second device is a network device.

Specifically, the network device in the embodiments of the present application may be a base station, an access point, or a device in communication with a wireless terminal by using one or more sectors at an air interface in an access network. When the network device is a base station, the base station may be configured to mutually convert a received over-the-air frame and an IP packet, and serve as a router between a wireless terminal and a remaining part of the access network, where the remaining part of the access network may include an IP network. The base station may also be configured to coordinate attribute management of the air interface. For example, the base station may be a base transceiver station (BTS) in a GSM system or a CDMA system, may be a NodeB in a wideband code division multiple access (WCDMA) system, or may be an eNB in an LTE system. This is not limited in the embodiments of the present application.

The terminal device in the embodiments of the present application may be a device that provides a user with voice and/or data connectivity, a handheld device with a wireless connection function, or another processing device connected to a wireless modem. The terminal device may alternatively be a wireless terminal. The wireless terminal may communicate with one or more core networks by using a radio access network (RAN). The wireless terminal may be a mobile terminal, such as a mobile phone (also referred to as a “cellular” phone) and a computer with a mobile terminal. The computer with a mobile terminal, for example, may be a portable, pocket-sized, handheld, computer built-in, or vehicle-mounted mobile apparatus, which exchanges voice and/or data with the radio access network. For example, the wireless terminal may alternatively be a device such as a personal communication service (PCS) phone, a cordless telephone set, a session initiation protocol (SIP) phone, a wireless local loop (WLL) station, or a personal digital assistant (PDA). The wireless terminal may also be called a system, a subscriber unit, a subscriber station, a mobile station, a mobile console (Mobile), a remote station, an access point (AP), a remote terminal, an access terminal (AT), a user terminal, a user agent, a user device, or user equipment (UE). The embodiments of the present application are not limited thereto.

The following describes the embodiments of the present application in detail with reference to the accompanying drawings of this specification.

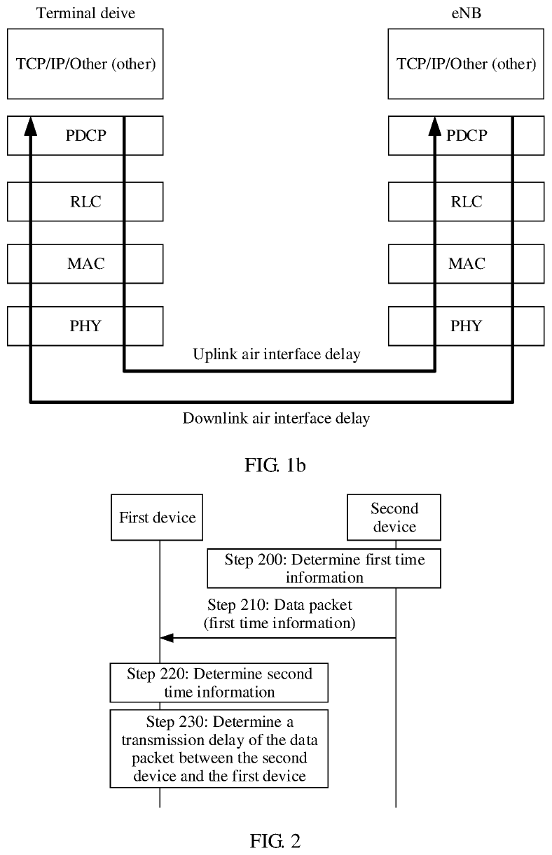

As shown in FIG. 2, a data packet sending and receiving method in an embodiment of the present application includes the following steps.

Step 200: A second device determines first time information that a data packet arrives at a PDCP layer of the second device.

Step 210: The second device sends the data packet to a first device, where the data packet includes the first time information.

Step 220: After receiving the data packet, the first device determines second time information that the data packet leaves a PDCP layer of the first device.

Step 230: The first device determines a transmission delay of the data packet between the second device and the first device based on the first time information and the second time information.

In this embodiment of the present application, it is determined that the transmission delay of the data packet between the second device and the first device meets a transmission delay of a data packet defined in an NR system. Therefore, when the technical solution in this embodiment of the present application is applied to the NR system, accuracy of measurement of the transmission delay of the data packet is improved.

It should be noted that, in this embodiment of the present application, when being specifically implemented, the first time information and the second time information may be implemented in a form of a timestamp, or in another form. This is not limited in this embodiment of the present application.

It should be understood that the first time information in this embodiment of the present application includes first absolute time information or first relative time information, and the second time information includes second absolute time information or second relative time information.

Relative time information may be indicated by using frame information, for example, a radio frame number, a subframe number, and an offset. The relative time information may include the radio frame number, the subframe number, and the offset. Alternatively, the relative time information may be other information used to indicate a radio frame number, a subframe number, and an offset, such as a sequence. This is not limited in this embodiment of the present application.

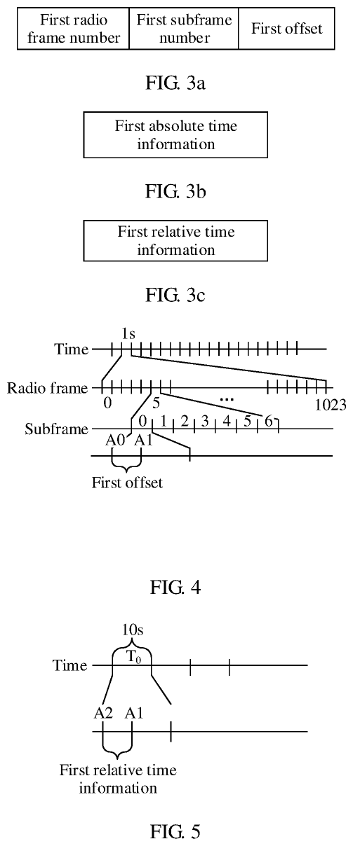

For example, formats used for the first time information in this embodiment of the present application are shown in FIG. 3a to FIG. 3c.

As shown in FIG. 3a, the first time information includes a first offset, and a first radio frame number and a first subframe number that are used when the data packet is received at the PDCP layer of the second device, and the first offset is used to indicate an offset of the data packet in a subframe identified by the first subframe number.

It should be noted that the subframe identified by the first subframe number is located in a radio frame identified by the first radio frame number.

It should be further noted that a location sequence of the first offset, the first subframe number, and the first radio frame number is not limited in this embodiment of the present application, and the format of the first time information shown in FIG. 3a is merely an example for description.

It is assumed that a slot structure in a communications system is shown in FIG. 4, a radio frame number cycles once in a second (s), and a specific 1 s includes 1024 radio frames. The radio frames are in a one-to-one correspondence with radio frame numbers 0 to 1023, each radio frame includes seven subframes, and the subframes are in a one-to-one correspondence with subframe numbers 0 to 7. If a subframe whose subframe number is 0 in a radio frame identified by a radio frame number 5 is used to send the data packet, a start location in which the data packet is carried in the subframe is A1, and A0 is a start location of the subframe whose subframe number is 0, a size between A1 and A0 is the first offset. In a specific implementation, if a time difference between A0 and A1 is 50 microseconds (ps), the first offset may be directly represented as 50 microseconds (μs), or may be an identifier, where the identifier is corresponding to 50 μs. For example, the identifier may be a positive integer. In addition, the identifier may alternatively be other information. When the identifier is other information, an implementation is similar to the implementation in which the identifier is a positive integer. Details are not described herein again.

The format of the first time information may alternatively be shown in FIG. 3b. The first time information is the first absolute time information of the data packet received at the PDCP layer of the second device. It should be understood that the first absolute time information may be a specific moment, for example, 12:00:00 on May 10, 2017. The first absolute time information may alternatively be an identifier. For example, the identifier may be a positive integer, and a correspondence rule between a positive integer and a specific moment is pre-configured. In this way, after a specific time at which the data packet is received at the PDCP layer of the second device is determined, a positive integer corresponding to the specific time may be determined, and the positive integer is sent to the first device. Compared with sending a specific moment directly to the first device, this manner reduces a quantity of bits of the first time information. In addition, the identifier may alternatively be other information, such as a sequence. When the identifier is other information, an implementation is similar to the implementation in which the identifier is a positive integer. Details are not described herein again.

In addition, the format of the first time information may alternatively be shown in FIG. 3c. The first time information is the first relative time information. The first relative time information is used to indicate an interval that a first moment deviates from a first target moment, the first moment is a time at which the data packet is received at the PDCP layer of the second device, the first target moment is a start moment of a period in which the first moment is located, and duration of the period in which the first moment is located is preset duration. It should be noted that the preset duration may be specifically set based on an actual situation. This is not limited herein. It should be further noted that, in this embodiment of the present application, the time at which the data packet is received at the PDCP layer of the second device is a time at which the data packet sent at an upper layer of the second device is received at the PDCP layer of the second device.

For example, as shown in FIG. 5, the preset duration is 10 s, the first moment is A1, the first relative time information is an interval of A1 relative to A2, and A2 is a start moment of a period T0 in which A1 is located. In specific implementation, the first relative time information may be an actual time difference between A2 and A1. For example, if the time difference between A2 and A1 is 1 s, the first relative time information may be 1 s, or the first relative time information is an identifier. For example, the identifier may be a positive integer. When the time difference between A2 and A1 is 1 s, is corresponds to a positive integer N0, the first relative time information is N0, and a correspondence rule between a positive integer and a relative time may be preconfigured. When the identifier is other information, an implementation is similar to the implementation in which the identifier is a positive integer. Details are not described herein again.

To enable the first device to know the format used for the first time information, in some embodiments, the data packet further includes a first identifier, and the first identifier is used to identify the format used for the first time information.

For example, if the first identifier is a positive integer, when the first time information includes the radio frame number, the subframe number, and the offset, the first identifier is 0; when the first time information is the first absolute time information, the first identifier is 1; or when the first time information is the first relative time information, the first identifier is 2. In addition, the first identifier may further be other information such as a sequence. Details are not described herein again.

In some embodiments, the first time information and the first identifier are carried in a PDCP header of the data packet.

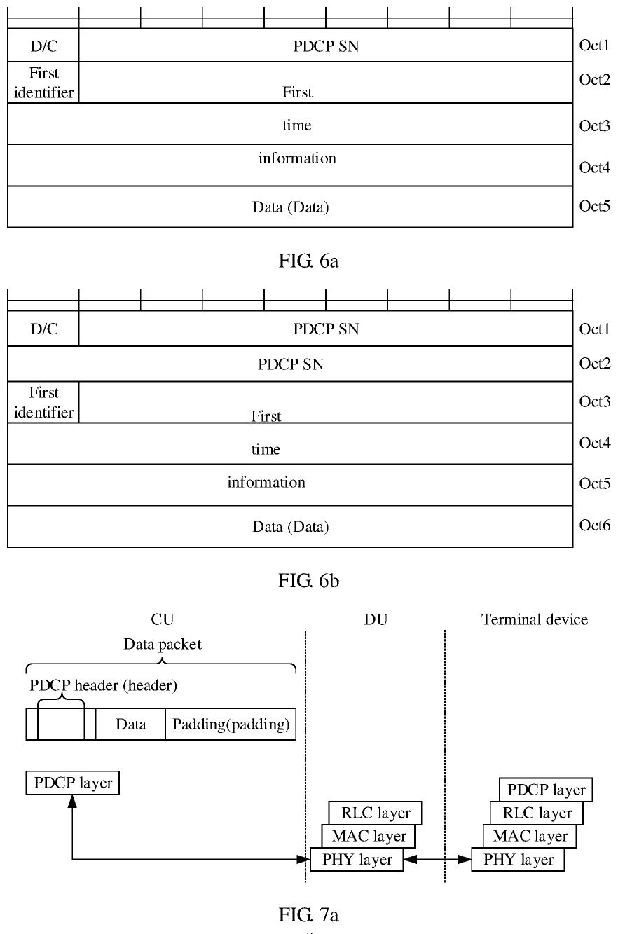

Specifically, the data packet in this embodiment of the present application is a PDCP protocol data unit (PDU). Therefore, the PDCP header is also referred to as a PDCP PDU header. For example, when a PDCP sequence number in the data packet is a short sequence number, a format of the data packet may be shown in FIG. 6a. When a PDCP sequence number in the data packet is a long sequence number, a format of the data packet may be shown in FIG. 6b. It should be noted that, in this embodiment of the present application, the first time information and the first identifier may alternatively be carried in a payload part of the data packet.

A specific implementation of the second time information is similar to that of the first time information. In some embodiments, to facilitate calculation of a transmission delay of the data packet, when the first time information includes the first offset, and the first radio frame number and the first subframe number that are used when the data packet is received at the PDCP layer of the second device, the second time information includes a second offset, and a second radio frame number and a second subframe number that are used when the data packet is sent at the PDCP layer of the first device, and the second offset is used to indicate an offset of the data packet in a subframe identified by the second subframe number. When the first time information is the first absolute time information of the data packet received at the PDCP layer of the second device, the second time information is the second absolute time information of the data packet sent at the PDCP layer of the first device. When the first time information is the first relative time information, the second time information is the second relative time information, the second relative time information is used to indicate a interval that a second moment deviates from a second target moment, the second moment is a time at which the data packet is sent at the PDCP layer of the first device, the second target moment is a start moment of a period in which the second moment is located, and duration of the period in which the second moment is located is the preset duration. It should be noted that the first device and the second device use the same preset duration.

It should be understood that, in this embodiment of the present application, that the data packet is sent at the PDCP layer of the first device means that the data packet is sent at the PDCP layer of the first device to an upper layer of the PDCP layer of the first device.

It should be noted that, in this embodiment of the present application, specific implementations of the first time information and the second time information may be different. For example, when the first time information and the second time information are different, the first device may determine the transmission delay of the data packet based on the first time information and the second time information in the following manner: Specifically, the first device determines, based on the first time information, an absolute time at which the data packet is received at the PDCP layer of the second device, and determines, based on the second time information, an absolute time at which the data packet is sent at the PDCP layer of the first device, to determine the transmission delay of the data packet between the second device and the first device.

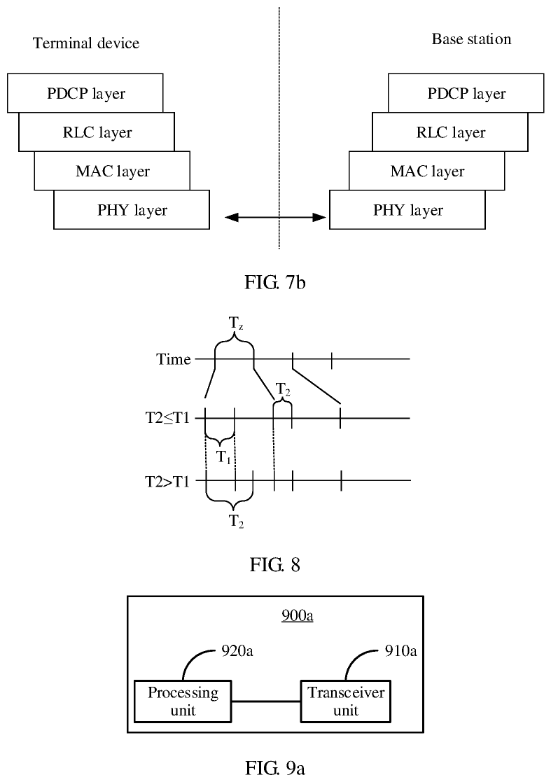

In addition, the NR system includes a cloud deployment scenario and a non-cloud deployment scenario. In the cloud deployment scenario, as shown in FIG. 7a, a PDCP layer of a base station is separated from a radio link control (RLC) layer, a media access control (MAC) layer, and a physical (PHY) layer, where an entity of the PDCP layer is a central unit (CU), and an entity including the RLC layer, the MAC layer, and the PHY layer is a distributed unit (DU). Because the PDCP layer is separated from the MAC layer, the PDCP layer cannot sense the radio frame number, the subframe number, and the offset that are used for sending or receiving the data packet. Therefore, when the second device is a base station, the first time information may be absolute time information, or may be predefined relative time information. When the first device is a base station, the second time information may be absolute time information, or may be predefined relative time information. In the non-cloud deployment scenario, as shown in FIG. 7b, the PDCP layer of the base station is not separated from the RLC layer, the MAC layer, and the PHY layer. Therefore, the PDCP layer of the base station can sense the radio frame number, the subframe number, and the offset that are used for sending or receiving the data packet. Therefore, when the second device is a base station, the first time information may be the radio frame number, the subframe number, and the offset that are used for sending the data packet, may be absolute time information, or may be predefined relative time information. When the first device is a base station, the second time information may be the radio frame number, the subframe number, and the offset that are used when the data packet is sent at the PDCP layer of the first device, may be absolute time information, or may be predefined relative time information.

For example, when both the first time information and the second time information are represented by using the radio frame number, the subframe number, and the offset, the first device may determine the transmission delay of the data packet between the second device and the first device in the following manner

$$T = \{ \begin{matrix}( {SFN}_{2} - {SFN}_{1} ) \times {T}_{f} + ( {SSFN}_{2} - {SSFN}_{1} ) \times {T}_{sf} + ( {SOFF}_{2} - {SOFF}_{1} ) & {SFN}_{2} \geq {SFN}_{1} ; \\ {T}_{0} + ( {SFN}_{2} - {SFN}_{1} ) \times {T}_{f} + ( {SSFN}_{2} - {SSFN}_{1} ) \times {T}_{sf} + ( {SOFF}_{2} - {SOFF}_{1} ) & {SFN}_{2} < {SFN}_{1} .\end{matrix} ,$$

where T is the transmission delay of the data packet between the second device and the first device, SFN₁ is the first radio frame number, SSFN₁ is the first subframe number, SOFF₁ is the first offset, SFN₂ is the second radio frame number, SSFN₂ is the second subframe number, SOFF₂ is the second offset, T_{f} is duration of a radio frame, T_{sf} is duration of a subframe, and T₀ is duration used for one cycle of a radio frame number.

For example, when SFN₁ meets SFN₁=4, SSFN₁ meets SSFN₁=3, SOFF₁ meets SOFF₁=0, SFN₂ meets SSFN₂=6, SSFN₂ meets SSFN₂=4, and SOFF₂ meets SOFF₂=0, the first device determines that the radio frame number SFN₁ and the radio frame number SFN₂ number are in a cycle period of the radio frame numbers, and T meets T=(6−4)×T_{f}+(4−3)×T_{sf}+(0−0)=2T_{f}+T_{sf}; or when SEN₁ meets SFN₁=4, SSFN₁ meets SSFN₁=3, SOFF₁ meets SOFF₁=0, SFN₂ meets SFN₂=2, SSFN₂ meets SSFN₂=4, and SOFF₂ meets SOFF₂=0, the first device determines that the radio frame number SFN₁ and the radio frame number SFN₂ are separately in two cycle periods of the radio frame numbers, and T meets T=T₀+(2−4)×T_{f}+(4−3)×T_{sf}+(0−0)=T₀−2T_{f}+T_{sf}.

It should be noted that, generally, when SFN₂ is less than SFN₁, the first device considers that there is one-period difference between a period in which SFN₂ is located and a period in which SFN₁ is located, and when a period difference between SFN₂ and SFN₁ is greater than one period, the first device is likely to unable to receive the data packet. To enable the first device to more accurately determine periods of radio frame numbers of radio frames in which SFN₂ and SFN₁ are located, a parameter of the period of the radio frame number is carried in the data packet, for example, a parameter of the period of the radio frame number is added to the first time information.

When the first time information and the second time information are represented by using the predefined relative time information, if the relative time information is a time offset, the first device may determine the transmission delay of the data packet between the second device and the first device in the following manner:

$$T = \{ \begin{matrix}{T}_{2} - {T}_{1} & {T}_{2} > {T}_{1} ; \\ {T}_{z} + ( {T}_{2} - {T}_{1} ) & {T}_{2} \leq {T}_{1} .\end{matrix} ,$$

where T is the transmission delay of the data packet between the second device and the first device, T₁ is the first relative time information, T₂ is the second relative time information, and T_{z} is the preset duration.

For example, as shown in FIG. 8, the radio frame number cycles once every T_{z}, T₁ is the first relative time information, and T₂ is the second relative time information. When T₂ and T₁ meets T₂≤T₁, the second target moment B is a start moment of an (N+1)^{th} period, or when T₂ and T₁ meets T₂>T₁, the second target moment is a start moment of an N^{th} period, where duration of the period is the preset duration, and the preset duration may be set based on an actual situation.

When both the first time information and the second time information are represented by using absolute time, the transmission delay of the data packet between the second device and the first device is:

T=T₂−T₁,

where T is an air interface delay of the data packet, T₁ is the first absolute time information, and T₂ is the second absolute time information.

In addition, it should be noted that, in a downlink communication direction, the second device is a base station, and the first device is a terminal device. After the terminal device acknowledges the transmission delay of the data packet between the second device and the first device. To facilitate the base station to evaluate a downlink data packet transmission delay, the terminal device reports the transmission delay of the data packet to the base station. Specifically, the terminal device may report the delay at a service packet level, or may report the delay periodically or statistically of an event. For example, when reporting the delay at the service packet level, the terminal device may report a transmission delay of a data packet to the base station every time the terminal device determines the transmission delay of the data packet. When reporting the transmission delay periodically, the terminal device may report, once every preset duration, transmission delays of data packets determined by the terminal device. When reporting the transmission delay statistically of an event, the terminal device may report a transmission delay of each data packet to the base station after the terminal device determines a transmission delay of a data packet the meets a preset quantity. In addition, when reporting the transmission delay statistically of an event, the terminal device may further be triggered by a specific event to report the transmission delay of the data packet to the base station. For example, the terminal device determines, within a continuous period of time, that the transmission delay of the data packet is not greater than a specific threshold. The specific threshold may be sent by the network device to the terminal device, or may be preset in the terminal device. This is not limited herein.

The base station collects statistics about transmission delays of data packets in uplink communication direction or the downlink communication direction, and may present the statistics by using a log or traffic statistics.

Based on a same concept, an embodiment of the present application further provides a data packet receiving device, and the device is configured to perform an action or a function of the first device in the foregoing method embodiment.

Based on a same concept, an embodiment of the present application further provides a data packet sending device, and the device is configured to perform an action or a function of the second device in the foregoing method embodiment.

An embodiment of the present application further provides a communications system, including the data packet sending device and the data packet receiving device in the foregoing embodiments.

For brevity, for content of an apparatus part, specifically refer to the method embodiments. Details are not repeatedly described.

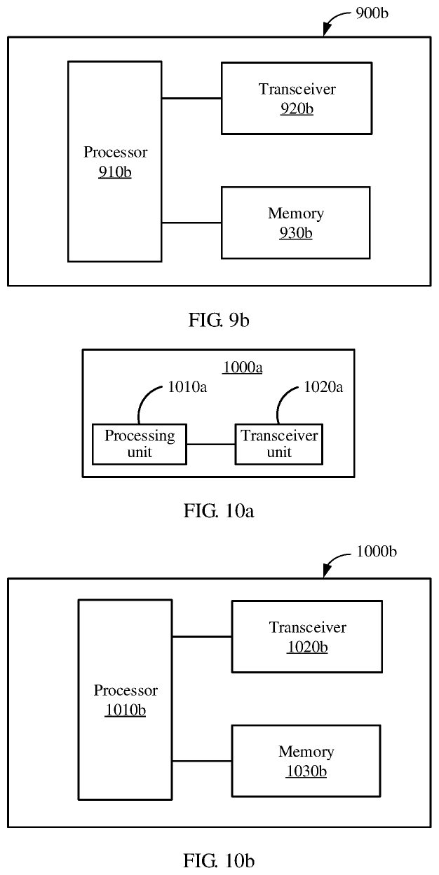

As shown in FIG. 9a, a data packet receiving device 900a in an embodiment of the present application includes a transceiver 910a and a processor 920a. The transceiver 910a is configured to receive a data packet sent by a second device, and the data packet includes first time information that the data packet arrives at a packet data convergence protocol PDCP layer of the second device. The processor 920a is configured to: determine second time information that the data packet leaves the PDCP layer of the device, and determine a transmission delay of the data packet between the second device and the device based on the first time information and the second time information.

In some embodiments, the first time information includes first absolute time information or first relative time information. The second time information includes second absolute time information or second relative time information.

In some embodiments, the first relative time information includes a first offset, and a first radio frame number and a first subframe number that are used when the data packet is received at the PDCP layer of the second device, and the first offset is used to indicate an offset of the data packet in a subframe identified by the first subframe number.

In some embodiments, the first relative time information is used to indicate a interval that a first moment deviates from a first target moment, the first moment is a time at which the data packet is received at the PDCP layer of the second device, the first target moment is a start moment of a period in which the first moment is located, and duration of the period in which the first moment is located is preset duration.

In some embodiments, the second relative time information includes a second offset, and a second radio frame number and a second subframe number that are used when the data packet is sent at the PDCP layer of the device 900a, and the second offset is used to indicate an offset of the data packet in a subframe identified by the second subframe number.

In some embodiments, the transmission delay T of the data packet between the second device and the device 900a meets the following expression:

$$T = \{ \begin{matrix}( {SFN}_{2} - {SFN}_{1} ) \times {T}_{f} + ( {SSFN}_{2} - {SSFN}_{1} ) \times {T}_{sf} + ( {SOFF}_{2} - {SOFF}_{1} ) & {SFN}_{2} \geq {SFN}_{1} ; \\ {T}_{0} + ( {SFN}_{2} - {SFN}_{1} ) \times {T}_{f} + ( {SSFN}_{2} - {SSFN}_{1} ) \times {T}_{sf} + ( {SOFF}_{2} - {SOFF}_{1} ) & {SFN}_{2} < {SFN}_{1} .\end{matrix} ,$$

where SFN₁ is the first radio frame number, SSFN₁ is the first subframe number, SOFF₁ is the first offset, SFN₂ is the second radio frame number, SSFN₂ is the second subframe number, SOFF₂ is the second offset, T_{f} is duration of a radio frame, T_{sf} is duration of a subframe, and T₀ is duration used for one cycle of a radio frame number.

In some embodiments, the second relative time information is used to indicate a interval that a second moment deviates from a second target moment, the second moment is a time at which the data packet is sent at the PDCP layer of the device, the second target moment is a start moment of a period in which the second moment is located, and duration of the period in which the second moment is located is the preset duration.

In some embodiments, the transmission delay T of the data packet between the second device and the device 900a meets the following expression:

$$T = \{ \begin{matrix}{T}_{2} - {T}_{1} & {T}_{2} > {T}_{1} ; \\ {T}_{z} + ( {T}_{2} - {T}_{1} ) & {T}_{2} \leq {T}_{1} .\end{matrix} ,$$

where T₁ is the first relative time information, T₂ the second relative time information, and T_{z} is the preset duration.

In some embodiments, the data packet further includes a first identifier. The first identifier is used to identify a format used for the first time information.

The processor 920a is configured to determine, based on the format that is used for the first time information and that is identified by the first identifier, the second time information that the data packet leaves the PDCP layer of the device.

In some embodiments, the first time information and the first identifier are carried in a PDCP header of the data packet.

In some embodiments, when the device 900a is a terminal device and the second device is a network device, the transceiver 910a is further configured to send the transmission delay to the second device.

It should be noted that, in this embodiment of the present application, the processor 920a may be implemented by a processor, and the transceiver 910a may be implemented by a transceiver. Specifically, the transceiver includes a receiver and a transmitter, the receiver is configured to receive a signal or data, and the transmitter is configured to send a signal or data.

FIG. 9b is a schematic structural diagram of hardware of a data packet receiving device 900b according to an embodiment of the present application. The device 900b may include a processor 910b, a transceiver 920b, and a memory 930b. The memory 930b may be configured to store a program/code pre-installed when the device 900b is delivered from a factory, or may store code executed by the processor 910b, or the like.

The processor 910b may be a general-purpose central processing unit (CPU), a microprocessor, an application-specific integrated circuit (ASIC), or one or more integrated circuits, and is configured to perform a related operation, to implement technical solutions provided in the embodiments of the present application.

It should be noted that although only the processor 910b, the transceiver 920b, and the memory 930b are shown in the device 900b shown in FIG. 9b, persons skilled in the art should understand that the device 900b further includes another component for implementing normal operation. In addition, based on a specific requirement, persons skilled in the art should understand that the device 900b may further include hardware components for implementing additional functions. In addition, persons skilled in the art should understand that the device 900b may include components or modules for implementing this embodiment of the present application, but does not include each of the components shown in FIG. 9b.

Persons of ordinary skill in the art may understand that all or some of the processes of the methods in the embodiments may be implemented by a computer program instructing related hardware. The program may be stored in a computer readable storage medium. When the program runs, the processes of the methods in the embodiments are performed. The foregoing storage medium may include: a magnetic disk, an optical disc, a read-only memory (ROM), or a random access memory (RAM), and or the like.

As shown in FIG. 10a, a data packet sending device 1000a in an embodiment of the present application includes a processor 1010a and a transceiver 1020a. The processor 1010a is configured to determine first time information that a data packet arrives at a packet data convergence protocol PDCP layer of the device. The transceiver 1020a is configured to send the data packet to a first device, where the data packet includes the first time information, so that the first device determines a transmission delay of the data packet between the device and the first device based on the first time information.

In some embodiments, the first time information includes first absolute time information or first relative time information.

In some embodiments, the first relative time information includes a first offset, and a first radio frame number and a first subframe number that are used when the data packet is received at the PDCP layer of the device, and the first offset is used to indicate an offset of the data packet in a subframe identified by the first subframe number.

In some embodiments, the first relative time information is used to indicate a interval that a first moment deviates from a first target moment, the first moment is a time at which the data packet is received at the PDCP layer of the device, the first target moment is a start moment of a period in which the first moment is located, and duration of the period in which the first moment is located is preset duration.

In some embodiments, the data packet further includes a first identifier. The first identifier is used to identify a format used for the first time information.

In some embodiments, the first time information and the first identifier are carried in a PDCP header of the data packet.

In some embodiments, when the first device is a terminal device and the device is a network device, the transceiver 1020a is further configured to: receive the transmission delay of the data packet that is between the first device and the second device and that is sent by the first device, and present the transmission delay in a form of a log or traffic statistics.

It should be noted that, in this embodiment of the present application, the processor 1010a may be implemented by a processor, and the transceiver 1020a may be implemented by a transceiver. Specifically, the transceiver includes a receiver and a transmitter, the receiver is configured to receive a signal or data, and the transmitter is configured to send a signal or data.

FIG. 10b is a schematic structural diagram of hardware of a data packet sending device 1000b according to an embodiment of the present application. The device 1000b may include a processor 1010b, a transceiver 1020b, and a memory 1030b. The memory 1030b may be configured to store a program/code pre-installed when the device 1000b is delivered from a factory, or may store code executed by the processor 1010b, or the like.

The processor 1010b may be a general-purpose CPU, a microprocessor, an ASIC, or one or more integrated circuits, and is configured to perform a related operation, to implement technical solutions provided in the embodiments of the present application.

It should be noted that although only the processor 1010b, the transceiver 1020b, and the memory 1030b are shown in the device 1000b shown in FIG. 10b, in a specific implementation process, persons skilled in the art should understand that the device 1000b further includes another component for implementing normal running. In addition, based on a specific requirement, persons skilled in the art should understand that the device 1000b may further include hardware components for implementing other additional functions. In addition, persons skilled in the art should understand that the device 1000b may include components or modules for implementing this embodiment of the present application, but does not include each of the components shown in FIG. 10b.

Persons of ordinary skill in the art may understand that all or some of the processes of the methods in the embodiments may be implemented by a computer program instructing related hardware. The program may be stored in a computer readable storage medium. When the program runs, the processes of the methods in the embodiments are performed. The storage medium may be a magnetic disk, an optical disk, a ROM or RAM, and the like.

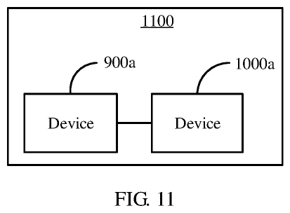

As shown in FIG. 11, a communications system 1100 in an embodiment of the present application includes the device 900a shown in FIG. 9a and the device 1000a shown in FIG. 10a.

The devices shown in FIG. 9a, FIG. 9b, FIG. 10a, and FIG. 10b are specifically described by using an example in which a first wireless protocol layer is a PDCP layer and a second wireless protocol layer is a PDCP layer. When the first wireless protocol layer is an SDAP layer, and the second wireless protocol layer is an SDAP layer, or the first wireless protocol layer and the second wireless protocol layer each are another layer, a manner of determining an air interface delay is similar. Details are not described herein again.

Persons skilled in the art should understand that the embodiments of the present application may be provided as a method, a system, or a computer program product. Therefore, the present application may use a form of hardware only embodiments, software only embodiments, or embodiments with a combination of software and hardware. Moreover, the present application may use a form of a computer program product that is implemented on one or more computer-usable storage media (including but not limited to a disk memory, a CD-ROM, an optical memory, and the like) that include computer usable program code.

The present application is described with reference to the flowcharts and/or block diagrams of the method, the device (system), and the computer program product according to the embodiments of the present application. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of any other programmable data processing device to generate a machine, so that the instructions executed by the computer or the processor of any other programmable data processing device generate an apparatus for implementing a specific function in one or more processes in the flowcharts and/or in one or more blocks in the block diagrams.

These computer program instructions may alternatively be stored in a computer readable memory that can instruct the computer or any other programmable data processing device to work in a specific manner, so that the instructions stored in the computer readable memory generate an artifact that includes an instruction apparatus. The instruction apparatus implements a specific function in one or more processes in the flowcharts and/or in one or more blocks in the block diagrams.

These computer program instructions may alternatively be loaded onto a computer or another programmable data processing device, so that a series of operations and steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the block diagrams.

The foregoing descriptions are merely specific implementations of the present disclosure, but are not intended to limit the protection scope of the present disclosure. Any variation or replacement readily figured out by a person skilled in the art within the technical scope disclosed in the present disclosure shall fall within the scope of protection of the present disclosure.

Obviously, persons skilled in the art can make various modifications and variations to the present application without departing from the spirit and scope of the present application. The present application is intended to cover modifications and variations of this application and fall within the scope of protection of the present application.

What is claimed is:

1. A method, comprising:
receiving, by a first device, a data packet, wherein the data packet comprises a first time information, the first time information indicating a time at which the data packet arrives at a first wireless protocol layer of a second device, the first wireless protocol layer is located in a user plane protocol stack of the second device, and a header of the data packet is a header of the first wireless protocol layer;
determining, by the first device, a second time information, wherein the second time information indicates a time at which the data packet leaves a second wireless protocol layer, the second wireless protocol layer is located in a user plane protocol stack of the first device, and the header of the data packet is parsed at the second wireless protocol layer; and
determining, by the first device, a transmission delay of the data packet between the second device and the first device based on the first time information and the second time information.

2. The method according to claim 1, wherein the first wireless protocol layer is a packet data convergence protocol (PDCP) layer of the second device, and the second wireless protocol layer is a PDCP layer of the first device; or
the first wireless protocol layer is a service data adaptation protocol (SDAP) layer of the second device, and the second wireless protocol layer is an SDAP layer of the first device.

3. The method according to claim 1, wherein
the first time information comprises:
a first absolute time information, or
a first relative time information; and
the second time information comprises:
a second absolute time information, or
a second relative time information.

4. The method according to claim 3, wherein the first relative time information comprises:
a first offset;
a first radio frame number; and
a first subframe number,
at least the first offset, the first radio frame number or the first subframe number is used by the first device when the data packet is received at the first wireless protocol layer, and the first offset indicating an offset of the data packet in a subframe identified by the first subframe number.

5. The method according to claim 3, wherein the first relative time information is used to indicate an interval that a first moment deviates from a first target moment, the first moment is a time the data packet is received at the first wireless protocol layer, the first target moment is a start moment of a period in which the first moment is located, and a duration of the period in which the first moment is located is a preset duration.

6. The method according to claim 3, wherein the second relative time information comprises:
a second offset;
a second radio frame number; and
a second subframe number,
at least the second offset, the second radio frame number or the second subframe number is used by the first device when the data packet is sent at the second wireless protocol layer, and the second offset indicating an offset of the data packet in a subframe identified by the second subframe number.

7. The method according to claim 1, wherein the transmission delay T of the data packet between the second device and the first device satisfies the following expression:
$$T = \{ \begin{matrix}( {SFN}_{2} - {SFN}_{1} ) \times {T}_{f} + ( {SSFN}_{2} - {SSFN}_{1} ) \times {T}_{sf} + ( {SOFF}_{2} - {SOFF}_{1} ) & {SFN}_{2} \geq {SFN}_{1} ; \\ {T}_{0} + ( {SFN}_{2} - {SFN}_{1} ) \times {T}_{f} + ( {SSFN}_{2} - {SSFN}_{1} ) \times {T}_{sf} + ( {SOFF}_{2} - {SOFF}_{1} ) & {SFN}_{2} < {SFN}_{1} .\end{matrix} ,$$
where SFN₁ is a first radio frame number, SSFN₁ is a first subframe number, SOFF₁ is a first offset, SFN₂ is a second radio frame number, SSFN₂ is a second subframe number, SOFF₂ is a second offset, T_{f} is a duration of a radio frame, T_{sf} is a duration of a subframe, and T₀ is a duration in one cycle of a radio frame number.

8. The method according to claim 3, wherein the second relative time information is used to indicate an interval that a second moment deviates from a second target moment, the second moment is a time the data packet is sent at the second wireless protocol layer, the second target moment is a start moment of a period in which the second moment is located, and a duration of the period in which the second moment is located is the preset duration.

9. The method according to claim 1, wherein the transmission delay T of the data packet between the second device and the first device satisfies the following expression:
$$T = \{ \begin{matrix}{T}_{2} - {T}_{1} & {T}_{2} > {T}_{1} ; \\ {T}_{z} + ( {T}_{2} - {T}_{1} ) & {T}_{2} \leq {T}_{1} .\end{matrix} ,$$
where T₁ is a first relative time information, T₂ is a second relative time information, and T_{z} is a preset duration.

10. The method according to claim 1, wherein the data packet further comprises:
a first identifier that identifies a format of the first time information; and
wherein the determining, by the first device, the second time information comprises:
determining, by the first device, the second time information based on the format of the first time information.

11. A device, comprising:
a transceiver, configured to receive a data packet, wherein the data packet comprises a first time information, the first time information indicating a time at which the data packet arrives at a first wireless protocol layer of another device, the first wireless protocol layer is located in a user plane protocol stack of the another device, and a header of the data packet is a header of the first wireless protocol layer; and
a processor coupled with the transceiver and a memory, the memory having computer readable instructions stored thereon that when executed by the processor cause the device to:
determine a second time information, and
determine a transmission delay of the data packet between the another device and the device based on the first time information and the second time information, wherein the second time information indicates a time at which the data packet leaves a second wireless protocol layer, the second wireless protocol layer is located in a user plane protocol stack of the device, and the header of the data packet is parsed at the second wireless protocol layer.

12. The device according to claim 11, wherein the first wireless protocol layer is a packet data convergence protocol (PDCP) layer of the another device, and the second wireless protocol layer is a PDCP layer of the device; or
the first wireless protocol layer is a service data adaptation protocol (SDAP) layer of the another device, and the second wireless protocol layer is an SDAP layer of the device.

13. The device according to claim 11, wherein
the first time information comprises:
a first absolute time information, or
a first relative time information; and
the second time information comprises:
a second absolute time information, or
a second relative time information.

14. The device according to claim 13, wherein the first relative time information comprises:
a first offset;
a first radio frame number; and
a first subframe number,
at least the first offset, the first radio frame number or the first subframe number is used by the device when the data packet is received at the first wireless protocol layer, and the first offset indicating an offset of the data packet in a subframe identified by the first subframe number.

15. The device according to claim 13, wherein the first relative time information is used to indicate an interval that a first moment deviates from a first target moment, the first moment is a time the data packet is received at the first wireless protocol layer, the first target moment is a start moment of a period in which the first moment is located, and a duration of the period in which the first moment is located is a preset duration.

16. The device according to claim 13, wherein the second relative time information comprises:
a second offset;
a second radio frame number; and
a second subframe number,
at least the second offset, the second radio frame number or the second subframe number is used by the device when the data packet is sent at the second wireless protocol layer, and the second offset indicating an offset of the data packet in a subframe identified by the second subframe number.

17. The device according to claim 11, wherein the transmission delay T of the data packet between the another device and the device satisfies the following expression:
$$T = \{ \begin{matrix}( {SFN}_{2} - {SFN}_{1} ) \times {T}_{f} + ( {SSFN}_{2} - {SSFN}_{1} ) \times {T}_{sf} + ( {SOFF}_{2} - {SOFF}_{1} ) & {SFN}_{2} \geq {SFN}_{1} ; \\ {T}_{0} + ( {SFN}_{2} - {SFN}_{1} ) \times {T}_{f} + ( {SSFN}_{2} - {SSFN}_{1} ) \times {T}_{sf} + ( {SOFF}_{2} - {SOFF}_{1} ) & {SFN}_{2} < {SFN}_{1} .\end{matrix} ,$$
where SFN₁ is a first radio frame number, SSFN₁ is a first subframe number, SOFF₁ is a first offset, SFN₂ is a second radio frame number, SSFN₂ is a second subframe number, SOFF₂ is a second offset, T_{f} is a duration of a radio frame, T_{sf} is a duration of a subframe, and T₀ is a duration in one cycle of a radio frame number.

18. The device according to claim 13, wherein the second relative time information is used to indicate an interval that a second moment deviates from a second target moment, the second moment is a time the data packet is sent at the second wireless protocol layer, the second target moment is a start moment of a period in which the second moment is located, and a duration of the period in which the second moment is located is the preset duration.

19. The device according to claim 11, wherein the transmission delay T of the data packet between the another device and the device satisfies the following expression:
$$T = \{ \begin{matrix}{T}_{2} - {T}_{1} & {T}_{2} > {T}_{1} ; \\ {T}_{z} + ( {T}_{2} - {T}_{1} ) & {T}_{2} \leq {T}_{1} .\end{matrix} ,$$
where T₁ is a first relative time information, T₂ is a second relative time information, and T_{z} is a preset duration.

20. A communications system, comprising:
a user equipment (UE); and
a base station, wherein
the base station is configured to determine a first time information, and send a data packet to the UE, wherein the data packet comprises the first time information;
the UE is configured to receive the data packet, wherein the data packet comprises the first time information, the first time information indicating a time at which the data packet arrives at a first wireless protocol layer, the first wireless protocol layer is located in a user plane protocol stack of the base station, and a header of the data packet is a header of the first wireless protocol layer;
the UE is configured to determine a second time information, wherein the second time information indicates a time at which the data packet leaves a second wireless protocol layer, the second wireless protocol layer is located in a user plane protocol stack of the UE, and the header of the data packet is parsed at the second wireless protocol layer; and
the UE is configured to determine a transmission delay of the data packet between the base station and the UE based on the first time information and the second time information.
